(19) United States
(12) Patent Application Publication
(10) Pub. No.: US 2007/0174532 A1
(43) Pub. Date: Jul. 26, 2007

(54) USB hub with sound output function

(76) Inventor: Frank Chen, Taipei Hsien (TW)

Correspondence Address: Frank Chen, 235 Chung-Ho, Box 8-24, Teipei, omitted

(21) Appl. No.: 11/509,428

(22) Filed: Aug. 25, 2006

(30) Foreign Application Priority Data
Jan. 20, 2006 (TW) 095201279

(51) Int. Cl. G06F 13/20; G06F 17/00

(52) U.S. Cl. 710/313; 700/94

(57) ABSTRACT

A USB hub comprises a USB mainframe unit for connecting to a computer through a connecting wire so as to support second USB expansion units to connect other peripherals; at least one fist USB expansion unit having a bus; the fist USB expansion unit supporting sound outputs; the logic switch having one end connected between the fist USB expansion unit and a USB controller; and another end of the logic switch being connected to a power supply end of the USB mainframe unit or an external power source. The USB mainframe unit, second USB mainframe units, USB controller, and logic switch are contained within a casing; the fist USB expansion unit is at a top surface of the casing for receiving a device uprightly. The casing is installed with a first plug connected to the external power source and a second plug connected to an earphone or a trumpet.

### FIELD OF THE INVENTION

The present invention relates to USB hubs, and in particular to a USB hub which can support sound output, other than the conventional use of expansion of USB interfaces and external devices.

### BACKGROUND OF THE INVENTION

USB (Universal serial bus) ports are widely used in electronic devices, for example computer devices and communication devices. By USB interfaces, the peripherals are connected to computer mainframes through USB buses. The connecting ports of the electronic devices have identical specification. Thereby the devices can be used as they are plugged into a computer device through the USB ports. That is, it is unnecessary to install a driver in the installation and detaching of the device.

To expanding the use of USB interface, generally, the USB mainframe unit is connected to a plurality of USB expansion units through a USB controller, which are integrated as a hub. Conventionally, other than expansion, the hub dose not provide other supports, such as sound outputs of MP3 player or media player. Thus the use of the hub is confined.

### SUMMARY OF THE INVENTION

Accordingly, the primary object of the present invention is to provide a USB hub which can support sound output, other than the conventional use of expansion of USB interfaces and external devices.

To achieve above objects, the present invention provides a USB hub which comprises a USB mainframe unit for connecting to a computer through a connecting wire so as to support second USB expansion units to connect other peripherals; at least one fist USB expansion unit having a bus; the fist USB expansion unit supporting sound outputs; the logic switch 5 having one end connected between the fist USB expansion unit and a USB controller; and another end of the logic switch 5 being connected to a power supply end of the USB mainframe unit or an external power source. The USB mainframe unit, second USB mainframe units, USB controller, and logic switch are contained within a casing; the fist USB expansion unit is at a top surface of the casing for receiving a device uprightly. The casing is installed with a first plug connected to the external power source and a second plug connected to an earphone or a trumpet; and the second plug is also connected to a sound output of the fist USB expansion unit.

The various objects and advantages of the present invention will be more readily understood from the following detailed description when read in conjunction with the appended drawing.

### BRIEF DESCRIPTION OF THE DRAWINGS

FIG. 1 shows the circuit of the present invention.

FIG. 2 shows the perspective view of the present invention.

FIG. 3 shows one application of the present invention.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

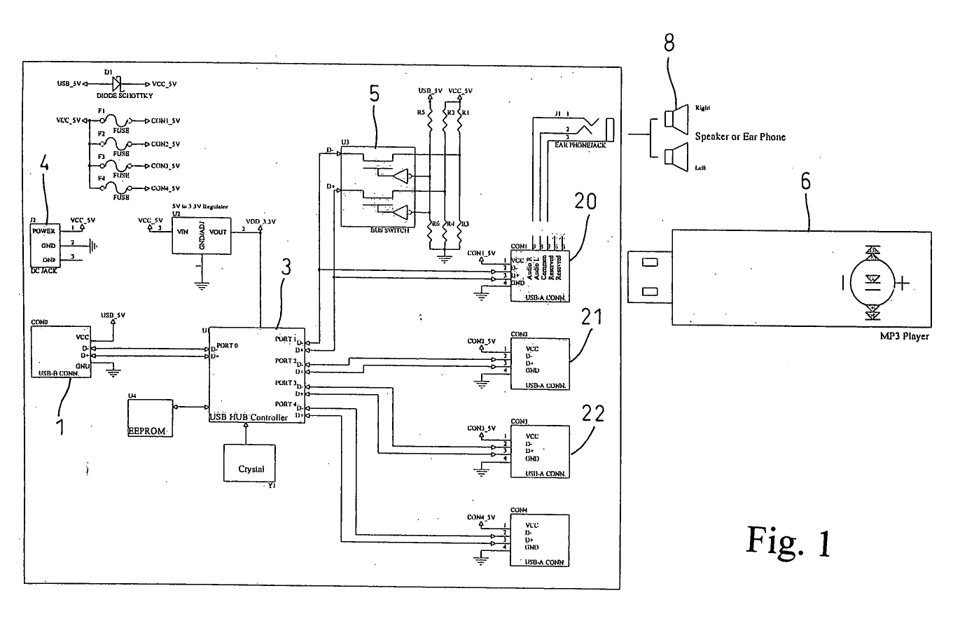

Referring to FIGS. 1 to 7, the present invention is illustrated. The USB hub of the present invention has the following elements.

A USB mainframe unit 1 is used to connect to for example a computer (not shown) through a connecting wire 10 for supporting other USB expansion units, 21, 22, 23 so as to connect other peripherals.

At least one fist USB expansion unit 20 has a bus. The fist USB expansion unit 20 can support sound outputs. As shown in the drawing, the fist USB expansion unit 20 has an Audio L connecting end and an Audio R connecting end. One end of the logic switch 5 is connected between the fist USB expansion unit 20 and a USB controller 3. Another end thereof is connected to a power supply end of the USB mainframe unit 1 or an external power source 4.

Thereby when the fist USB expansion unit 20 is connected to for example an MP3 player 6 or other sound source. Other than transmission or access data, if it is desired to play music, the logic switch 5 will detect the signals and cut off the data transmission work of the fist USB expansion unit 20. Then the fist USB expansion unit 20 supplies the power from the power supply end to the MP3 player 6 or output and transmission music data to the MP3 player 6.

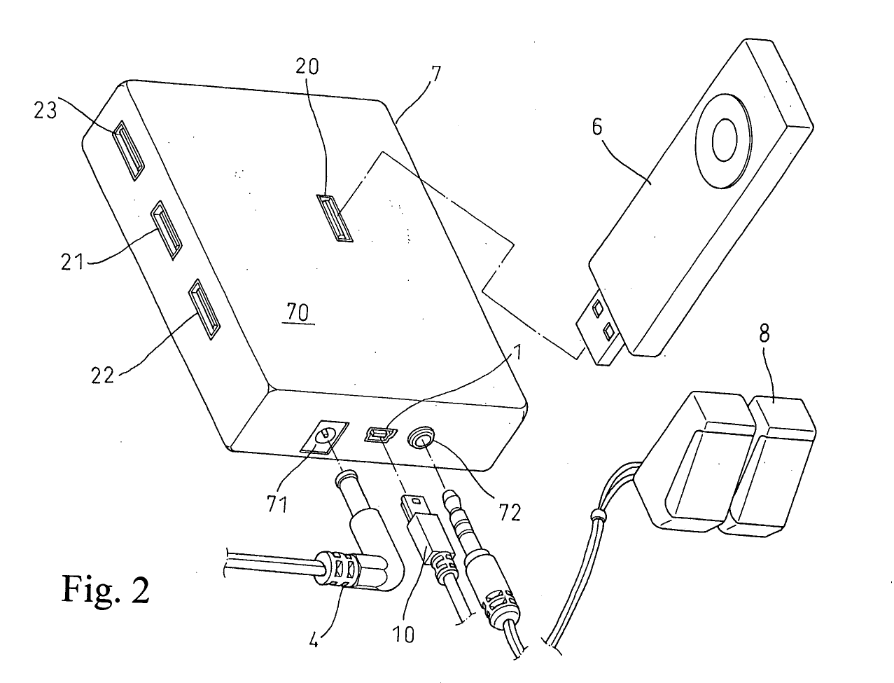

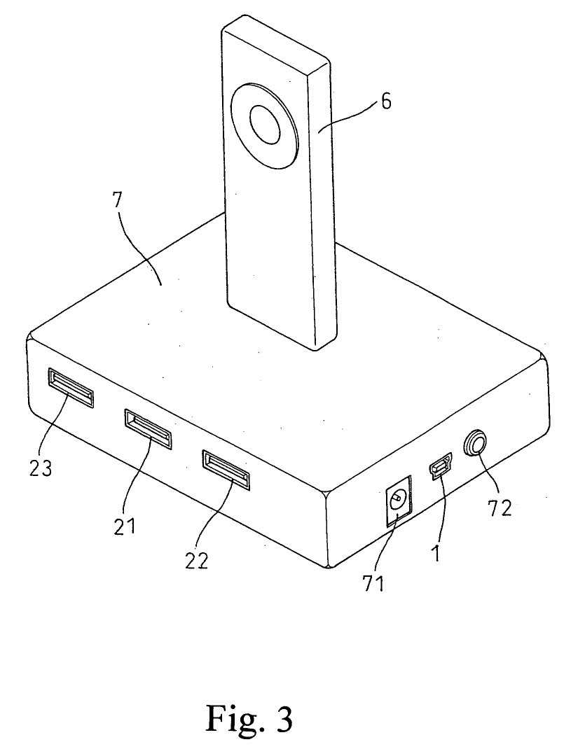

Referring to FIG. 2, an application of the present invention is illustrated. The USB hub has a casing 7. The USB mainframe unit I and the other USB expansion units, 21, 22, 23 are at the periphery of the casing 7. Especially, the fist USB expansion unit 20 is at a top surface 70 of the casing 7. For example the MP3 player 6 or Media player, etc. can be inserted to the casing 7 uprightly so that the casing 7 is used as a base, as shown in FIG. 3.

The casing 7 is installed with a first plug 71 connected to the external power source 4 and a second plug 72 connected to an earphone or a trumpet 8. The second plug 72 is also connected to a sound output of the fist USB expansion unit 20.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A USB hub comprising:
a USB mainframe unit for connecting to a computer through a connecting wire so as to support second USB expansion units to connect other peripherals;
at least one fist USB expansion unit having a bus; the fist USB expansion unit supporting sound outputs;
the logic switch having one end connected between the fist USB expansion unit and a USB controller; and another end of the logic switch being connected to a power supply end of the USB mainframe unit or an external power source.

2. The USB hub as claimed in claim 1, wherein the USB mainframe unit, second USB mainframe units, USB controller, and logic switch are contained within a casing; the fist USB expansion unit is at a top surface of the casing for receiving a device uprightly.

3. The USB hub as claimed in claim 2, wherein the device is an MP3 player or a media player.

4. The USB hub as claimed in claim 1, wherein the casing is installed with a first plug connected to the external power source and a second plug connected to an earphone or a trumpet; and the second plug is also connected to a sound output of the fist USB expansion unit.
